(19) United States
(12) Patent Application Publication
(10) Pub. No.: US 2021/0064750 A1
(43) Pub. Date: Mar. 4, 2021

(54) HEARING SYSTEM, THREAT RESPONSE SYSTEM, METHOD, AND PROGRAM

(71) Applicant: NEC Corporation, Minato-ku, Tokyo (JP)

(72) Inventors: Takahiro KAKUMARU, Tokyo (JP); Naoki SASAMURA, Tokyo (JP); Kei TAKAI, Tokyo (JP); Daichi OOZONO, Tokyo (JP)

(73) Assignee: NEC Corporation, Minato-ku, Tokyo (JP)

(21) Appl. No.: 16/981,046

(22) PCT Filed: Aug. 27, 2018
(86) PCT No.: PCT/JP2018/031514

§ 371 Date: Sep. 15, 2020

(30) Foreign Application Priority Data
Mar. 20, 2018 (JP) 2018-052077

(51) Int. Cl. G06F 21/56; G06F 16/245

(52) U.S. Cl. CPC G06F 21/566; G06F 2221/034; G06F 16/245

(57) ABSTRACT

A query creation means 82 creates, in accordance with the threat event detected, at least one query for use in identification of, as a cause of a threat, an event caused by the user in the user terminal or an event that has occurred in the user terminal due to the threat from among events that the user becomes aware of. A query transmission and reception means 83 transmits the query created to the notification recipient associated with the user identified and receives an answer to the query from the user. An attack identification means 84 identifies, in an attack model representing phases of a series of attacks identified based on a type of the threat, a corresponding one of the phases based on the answer. A first response execution means 85 executes a first response to the threat indicated by the attack model in accordance with the phase identified.

### TECHNICAL FIELD

The present invention relates to a hearing system, a threat response system, a threat response method, and a threat response program that execute a response to a threat that has occurred in a user terminal.

### BACKGROUND ART

Along with increases in damage caused cyberattacks, entities such as companies that are subject to cyberattacks have security detectors installed or have personnel responsible for security monitoring designated so as to monitor whether an external threat has intruded or emerged.

The personnel responsible for security monitoring, also called a computer security incident response team (CSIRT), monitors the intrusion or emergence of such a threat using the security detector. When a threat is actually detected, the personnel responsible for security monitoring take action such as isolation or disconnection of a terminal in which the threat is detected and, at the same time, make a necessary examination and analysis on a log and the like. For such an examination and analysis, a tool such as a forensic tool is used, for example.

The terminal in which the threat is detected is isolated using, for example, software defined network (SDN) technology. In general, the terminal is isolated manually by a terminal administrator (user) or a security administrator belonging to a terminal administration department under an instruction of the personnel responsible for security monitoring, but the terminal may be isolated automatically or by the personnel responsible for security monitoring using the function based on endpoint detection and response (EDR) in cooperation with an anti-advanced persistent threat device or the like. Note that what kind of threat is to be blocked is determined based on a security policy defined by a company (examples of such a security policy include executing strict responses to threats, emphasizing convenience of employees, and the like).

Further, after isolating the terminal, the personnel responsible for security monitoring confirm the action against the detected threat and further bring the terminal back into a connected state. Details of the confirmation include, for example, whether the threat has been detected but practically has no effect, whether action against the threat has been already taken (whether a virus has been removed by anti-virus software against the threat, or a clear installation has been made). Further, how to confirm whether action has been taken includes a method based on management using a log and the like, a method based on confirmation with a user, and the like.

There are several possible phases in threat detection. The cyber kill chain is known as a concept related to a structure where details of an attack are hierarchically organized. The cyber kill chain is a concept related breakdowns of an attacker's action. The hierarchical structure includes, for example, a reconnaissance phase at which information is collected and an exploitation phase at which an attack code is executed.

When a threat is detected, the personnel responsible for security monitoring recognize the type of the detected threat and infer an attack scenario based on the type of the threat. The personnel responsible for security monitoring confirm, based on the scenario thus inferred, a phase in the above-described cyber kill chain with reference to, for example, a detection log and the like.

Further, PTL 1 discloses a device that aids in security design efficient for a large-scale system. The device disclosed in PTL 1 receives a threat analysis result as input, and outputs, as a response policy candidate, a pattern of a response policy highly frequently derived from analysis results (actual results) accompanying security design made in the past.

### CITATION LIST

### Patent Literature

PTL 1: Japanese Patent Application Laid-Open No. 2016-045736

### SUMMARY OF INVENTION

### Technical Problem

However, there are some cases, depending on scales or business types of companies, where a complete security detection tool is not provided. For example, when a user terminal is equipped with a virus detection tool, but not equipped with a mechanism such as EDR, and thus the threat is not notified to the personnel responsible for security monitoring, it is difficult to recognize a phase in the cyber kill chain. Further, only the detection of the threat does not necessarily allow the recognition of the phase.

Further, when failure in detection sometimes occurs, it is difficult to recognize the phase in many cases. Furthermore, when a threat is detected due to an intentional action (for example, a response related to business) of the user, a work load on the personnel responsible for security monitoring may increase.

Further, the device disclosed in PTL 1 identifies a similar threat group similar in characteristics to each other and identifies a response policy. However, even when the device disclosed in PTL 1 is used, depending on detected details, there may be some threats that cannot be identified, thereby requiring more work load on the personnel responsible for security monitoring. Further, a problem arises that, even when the device disclosed in PTL 1 is used, a situation caused by the intentional action of the user as described above cannot be identified, and the work load on the personnel responsible for security monitoring increases accordingly.

It is therefore an object of the present invention to provide a hearing system, a threat response system, a threat response method, and a threat response program capable of executing a response to ensure security against threats while suppressing an increase in work load on personnel responsible for security monitoring.

### Solution to Problem

A hearing system according to the present invention includes a notification recipient identification means that uses a database in which a user terminal and a notification recipient associated with a user are associated with each other to identify the notification recipient associated with the user of the user terminal in which a threat event has been detected, a query creation means that creates, in accordance with the threat event detected, at least one query for use in identification of, as a cause of a threat, an event caused by the user in the user terminal or an event that has occurred in the user terminal due to the threat from among events that the user becomes aware of, a query transmission and reception means that transmits the query created to the notification recipient associated with the user identified and receives an answer to the query from the user, an attack identification means that identifies, in an attack model representing phases of a series of attacks identified based on a type of the threat, a corresponding one of the phases based on the answer, and a first response execution means that executes a first response to the threat indicated by the attack model in accordance with the phase identified.

A threat response system according to the present invention includes a threat event detection means that detects a threat event that has occurred in a user terminal, a notification recipient identification means that uses a database in which the user terminal and a notification recipient associated with a user are associated with each other to identify the notification recipient associated with the user of the user terminal in which the threat event has been detected, a query creation means that creates, in accordance with the threat event detected, at least one query for use in identification of, as a cause of a threat, an event caused by the user in the user terminal or an event that has occurred in the user terminal due to the threat from among events that the user becomes aware of, a query transmission and reception means that transmits the query created to the notification recipient associated with the user identified and receives an answer to the query from the user, an attack identification means that identifies, in an attack model representing phases of a series of attacks identified based on a type of the threat, a corresponding one of the phases based on the answer, and a first response execution means that executes a first response to the threat indicated by the attack model in accordance with the phase identified.

A threat response method according to the present invention includes using a database in which a user terminal and a notification recipient associated with a user are associated with each other to identify the notification recipient associated with the user of the user terminal in which a threat event has been detected, creating, in accordance with the threat event detected, at least one query for use in identification of, as a cause of a threat, an event caused by the user in the user terminal or an event that has occurred in the user terminal due to the threat from among events that the user becomes aware of, transmitting the query created to the notification recipient associated with the user identified and receiving an answer to the query from the user, identifying, in an attack model representing phases of a series of attacks identified based on a type of the threat, a corresponding one of the phases based on the answer, and executing a first response to the threat indicated by the attack model in accordance with the phase identified.

A threat response program according to the present invention causes a computer to execute notification recipient identification processing of using a database in which a user terminal and a notification recipient associated with a user are associated with each other to identify the notification recipient associated with the user of the user terminal in which a threat event has been detected, query creation processing of creating, in accordance with the threat event detected, at least one query for use in identification of, as a cause of a threat, an event caused by the user in the user terminal or an event that has occurred in the user terminal due to the threat from among events that the user becomes aware of, query transmission and reception processing of transmitting the query created to the notification recipient associated with the user identified and receiving an answer to the query from the user, attack identification processing of identifying, in an attack model representing phases of a series of attacks identified based on a type of the threat, a corresponding one of the phases based on the answer, and first response execution processing of executing a first response to the threat indicated by the attack model in accordance with the phase identified.

### Advantageous Effects of Invention

According to the present invention, it is possible to execute a response to ensure security against threats while suppressing an increase in work load on personnel responsible for security monitoring.

### BRIEF DESCRIPTION OF DRAWINGS

FIG. 1 It depicts a block diagram of a threat response system according to the present invention, illustrating an example of a configuration of a first exemplary embodiment.

FIG. 2 It depicts an explanatory diagram illustrating an example of a monitoring log.

FIG. 3 It depicts an explanatory diagram illustrating an example of a threat response history.

FIG. 4 It depicts a flowchart illustrating an example of an operation of the threat response system of the first exemplary embodiment.

FIG. 5 It depicts a block diagram of a threat response system according to the present invention, illustrating an example of a configuration of a second exemplary embodiment.

FIG. 6 It depicts an explanatory diagram illustrating an example of a policy table.

FIG. 7 It depicts a flowchart illustrating an example of an operation of the threat response system of the second exemplary embodiment.

FIG. 8 It depicts an explanatory diagram illustrating an example of a query table and examples of responses to a threat.

FIG. 9 It depicts an explanatory diagram illustrating an example of the query table and examples of responses to the threat.

FIG. 10 It depicts an explanatory diagram illustrating an example of the query table and examples of responses to the threat.

FIG. 11 It depicts an explanatory diagram illustrating an example of the query table and examples of responses to the threat.

FIG. 12 It depicts an explanatory diagram illustrating an example of a query table and examples of responses to a threat.

FIG. 13 It depicts an explanatory diagram illustrating an example of processing of displaying a notified query.

FIG. 14 It depicts an explanatory diagram illustrating an example of a notification given upon failure of identification of an attack.

FIG. 15 It depicts a block diagram schematically illustrating a hearing system according to the present invention.

FIG. 16 It depicts a block diagram schematically illustrating a threat response system according to the present invention.

### DESCRIPTION OF EMBODIMENTS

Hereinafter, exemplary embodiments of the present invention will be described with reference to the drawings.

### Exemplary Embodiment 1

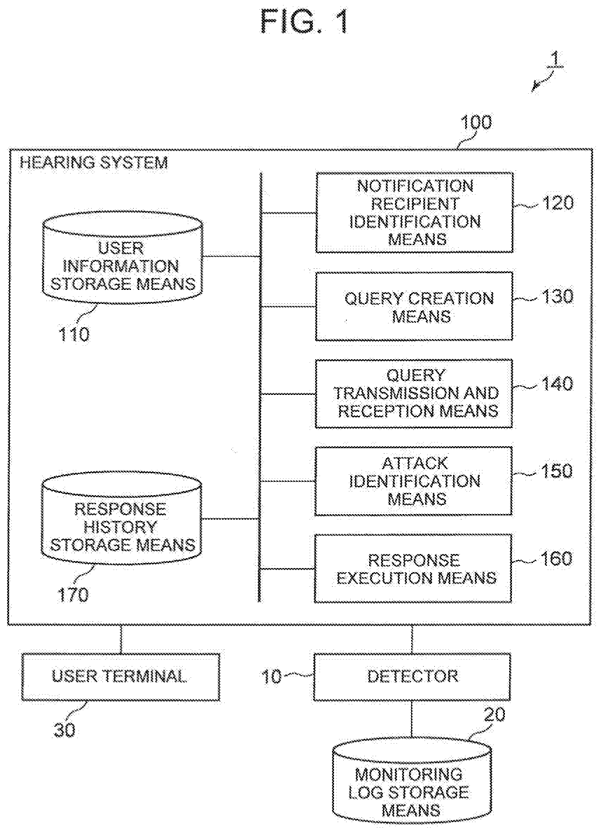

FIG. 1 is a block diagram of a threat response system according to the present invention, illustrating an example of a configuration of a first exemplary embodiment. A threat response system 1 of the present exemplary embodiment includes a detector 10, a monitoring log storage means 20, and a hearing system 100. The detector 10 and the hearing system 100 are communicatively coupled to a user terminal 30 serving as a detection target.

The detector 10 detects a threat event that has occurred in the user terminal 30. Then, the detector 10 stores a monitoring log indicating the detected threat event into the monitoring log storage means 20. Note that the detector 10 may use any desired method to detect the threat event, provided the method is a widely-used method.

For example, at a phase of “delivery” made by an attacker that is one of the phases of the cyber kill chain described above, a company (attacked entity) will make “access”. Specific examples of “access” include a case where the user terminal receives an e-mail to which an attack code or malware is attached and a case where the user terminal accesses a web page in which malware is implemented and then downloads the malware.

Besides, for example, at a phase of “installation” made by the attacker, the company will be brought into “infection”. Specific examples of “infection” include a case where an attack code is executed and a case where malware is installed by running a file in which the malware is implemented. Furthermore, it can be said that, at a phase of “command and control” made by the attacker, a terminal belonging to the company starts to communicate with a specific site (make “outbound communication”), so that the terminal is brought into a so-called onset state. Furthermore, at a phase of “action on objective” made by the attacker, for example, target information in the terminal belonging to the company is searched for, and the information is transmitted to the outside by means of, for example, the hypertext transfer protocol (HTTP) or file transfer protocol (FTP), and this state can be referred to as an onset state as well.

The detector 10 may have a function of a sandbox or EDR. For example, in order to detect that “access” has been made, the detector 10 may detect communication for downloading malware or an e-mail to which malware is attached with a sandbox of an anti-advanced persistent threat device. In addition, for example, in order to detect that “command and control” has been made, the detector 10 detects communication of which destination matches notification recipient information, at the time of infection with malware, held by the anti-advanced persistent threat device. Further, the detector 10 may detect suspicious behavior of the terminal, start of a suspicious process, or the like using the function of EDR.

The monitoring log storage means 20 stores a result of detection made by the detector 10 as a monitoring log. The monitoring log storage means 20 may further store, as the monitoring log, a result of detection made by another detector 10 or a result of detection made by the user terminal 30 itself. The monitoring log storage means 20 is implemented by, for example, a magnetic disk device.

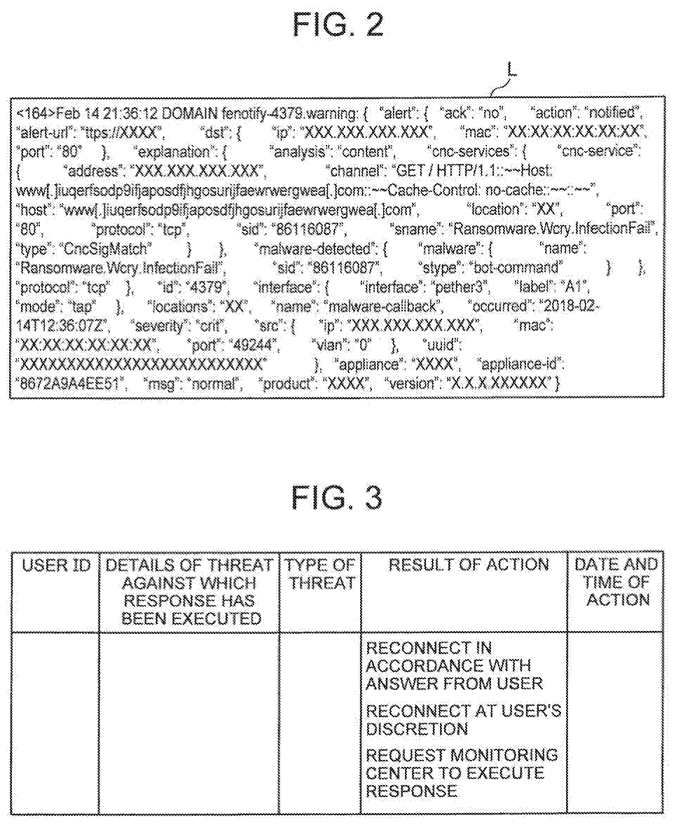

FIG. 2 is an explanatory diagram illustrating an example of the monitoring log. A monitoring log L illustrated in FIG. 2 is an example of the monitoring log when a callback called by ransomware is detected. For example, analyzing the monitoring log illustrated in FIG. 2 makes it possible to detect what kind of threat event has occurred in which user terminal 30.

The hearing system 100 includes a user information storage means 110, a notification recipient identification means 120, a query creation means 130, a query transmission and reception means 140, an attack identification means 150, a response execution means 160, and a response history storage means 170.

The user information storage means 110 stores a database in which the user terminal 30 and a notification recipient associated with a user are associated with each other. Note that the number of notification recipients for the user is not limited to one, and a plurality of notification recipients may be provided. The user information storage means 110 may further store notification recipients associated with other persons related to the user (for example, a manager of the user, personnel responsible for security monitoring who take care of a department to which the user belongs, and the like), with the notification recipients associated with the user terminal 30. This makes it possible to notify the user of the user terminal 30 and the other persons related to the user of necessary information.

The notification recipient identification means 120 uses the database stored in the user information storage means 110 to identify a notification recipient associated with the user of the user terminal 30 in which a threat event has been detected. The notification recipient thus identified is used as a notification recipient to which the query transmission and reception means 140 (to be described later) transmits a query.

The query creation means 130 creates a query in accordance with the detected threat event. Specifically, the query creation means 130 creates, in accordance with the detected threat event, a query for use in identification of, as a cause of a threat, an event caused by the user in the user terminal 30 or an event that has occurred in the user terminal 30 due to the threat from among events that the user becomes aware of Note that the number of queries created by the query creation means 130 is not limited to one, and two or more queries may be created. Examples of the query for use in identification of an event caused by the user in the user terminal 30 include a query for use in confirmation of whether access has been made to a specific site. Further, examples of the query for use in identification of an event that has occurred in the user terminal 30 due to the threat include a query for use in confirmation of operation conditions of the user terminal 30.

According to the present exemplary embodiment, phases of a series of attacks identified based on the type of threat are referred to as an attack model, as with the cyber kill chain described above. For example, in an example with reference to the detector 10 described above, the attack model is represented by a series of attacks indicating phases of “access”, “infection”, “outbound communication”, and “action on objective”. However, the attack model of the present exemplary embodiment is limited to neither the above-described four phases nor the cyber kill chain. The attack model may be any information from which each phase of a series of attacks can be identified based on the type of a threat.

The query creation means 130 creates, in accordance with the detected threat event, a query that allows at least identification of a phase in the above-described attack model to which the detected threat event belongs. Further, the query creation means 130 preferably creates a query that allows identification of a threat type of the detected threat event and a phase to which the detected threat event belongs. The query creation means 130 may create a query in accordance with one threat event, or alternatively, may create a query in accordance with a plurality of threat events. Combining threat events makes it is possible to narrow down the types of threats.

Specifically, a query table in which queries for determining suitability based on the type of a threat and the phase are defined is established in advance, and the query creation means 130 creates a query from the query table. Note that the query table may be set up for each threat event and may be structured to allow a corresponding query to be selected based on the threat event (thereby narrowing down queries). That is, when the type of a threat and the phase cannot be identifies based on the detected threat event alone, a necessary query is created from the detected threat event.

Further, some of the queries set in the query table may contain variables that can be set with information on the threat event. In this case, the query creation means 130 may extract information from the monitoring log and create a query containing a variable set with the extracted information. Examples of such a variable include an URL indicating an access destination and a name of an infected file.

For example, suppose a “CallBack” is detected as a threat event that makes outbound communication. In this case, the query creation means 130 may create a query that allows “outbound communication” or the type of a threat to be identified. Note that, from this threat event, it is assumed that the communication is made due to an infection with malware, access intentionally made by the user, or access made by the user unintentionally but by false operation. Therefore, the query creation means 130 may further create a query for identifying such causes. Note that details on the queries will be described later.

The query table may further have a process associated with an answer. The query table may further have likelihood of the phase or the type of a threat associated with the answer. For example, when an answer of “Yes” is given to a certain query, the likelihood of the phase or the type of a threat associated with the answer may be identified.

The query transmission and reception means 140 transmits the created query to the notification recipient associated with the user identified by the notification recipient identification means 120 and receives an answer to the query from the user. The query transmission and reception means 140 may transmit the query by e-mail, chat, short mail service (SMS), or the like. In this case, the query transmission and reception means 140 may receive the answer as a reply to an e-mail, chat, or SMS.

Further, the query transmission and reception means 140 may transmit an e-mail to which an application for answering the query is attached, or an e-mail with a uniform resource locator (URL) indicating a web page for answering the query. In this case, the query transmission and reception means 140 may receive the answer using a function of the attached application or a function with which the answer is entered into the web page.

Further, the query transmission and reception means 140 may sequentially transmit queries in synchronization with received answers, or alternatively, may collectively transmit queries and receive corresponding answers. Further, the query transmission and reception means 140 may transmit a query for collecting information that can be used later by the personnel responsible for security monitoring.

Further, the query transmission and reception means 140 may transmit a query indicating the suitability of the answer received from the user to a different user (for example, a manager of the user, a personnel responsible for security monitoring in a department to which the user belongs, a person related to the user, or the like) and receive a corresponding answer from the person related to the user. When a threat event occurs in the terminal being used, the user of the terminal may try to hide his/her action. Further, when the user is not aware of the action, the user may not be able to determine the suitability of the action. With this in mind, the query transmission and reception means 140 gives the query to the different user about the suitability of the answer, thereby increasing the reliability of the answer.

For example, when the user information storage means 110 stores a database in which the user of the user terminal 30 and the manager of the user are associated with each other, the query transmission and reception means 140 may transmit the query indicating the suitability of the answer received from the user to the manager and receive an answer to the query from the manager.

The attack identification means 150 identifies the phase in the attack model based on the received answer. Furthermore, the attack identification means 150 may identify the type of a threat based on the received answer. Specifically, the attack identification means 150 refers to the query table to identify the phase in the attack model based on the answer to the query from the user.

For example, when the likelihood of the phase or the type of a threat is associated with the answer in the query table, the attack identification means 150 identifies the phase in the attack model based on the likelihood associated with the answer.

Further, the attack identification means 150 may evaluate the likelihood of the identified phase based on the answer to each query from the user. For example, when the user takes action without his/her awareness, the user may not be aware of the action and thus may not be able to answer the query. Further, for example, when the user takes action intentionally, the user may distort the answer. Therefore, the attack identification means 150 may evaluate the likelihood of the answer for each phase, each type of a threat, or each combination of the phase and the type of a threat based on the degree of coincidence of answers indicating the phase to be identified. At this time, the attack identification means 150 may change the likelihood in a manner that depends on the presence or absence of an answer to a specific query. The attack identification means 150 may make the likelihood high (low) in a manner that depends on, for example, an answer to a critical query (a query that should always result in YES/NO determination, a query to check for inconsistencies, or the like). Note that whether the query is critical or not may be preset in the query table, for example.

The response execution means 160 executes a response to the threat indicated by the attack model in accordance with the identified phase. Further, when the type of a threat is identified, the response execution means 160 executes a response to the threat in accordance with the identified phase and the identified type of the threat.

The response to the threat is predetermined based on the phase, the type of the threat, and a combination of the phase and the type of the threat, and the response execution means 160 executes the predetermined response. Hereinafter, a response to be executed in accordance with the answer to the query will be referred to as a first response. That is, the response execution means 160 of the present exemplary embodiment executes the first response predetermined based on the identified phase, the identified type of the threat, or the combination of the identified phase and the identified type of the threat.

Specific examples of the first response include interrupting communication from the user terminal 30 or putting the user terminal 30 into a special network (quarantine network) for isolation. Herein, the quarantine network is a network in which a normal outbound connection and a connection to an internal server are blocked (hereinafter sometimes referred to as a normal network) and connections to a minimum number of servers are possible. According to the present exemplary embodiment, the quarantine network is, for example, a network connected only to the hearing system 100 or a site for downloading vaccine data. As described above, when a threat is detected, the response execution means 160 automatically disconnects the user terminal 30 from the normal network, preventing the other terminals from being affected and ensuring security against the threat.

However, the first response is not limited to such responses so-called network isolation. When a threat event is detected, the response execution means 160 activates a mechanism (for example, SDN, access control system, application control system, or the like) that controls access to a device, service, or system, or execution of a service or application. Alternatively, the response execution means 160 may read a user ID from the user information storage means 110 and perform control to execute an application service using the user ID in a restricted manner or to terminate the application service. The activation of such a mechanism allows a more suitable response to be executed on, for example, a cloud environment (Application as a service, Desktop as a service, or the like) where the network isolation would not be a suitable response.

Examples of the first response include running a forensic logging tool, removing an application indicating a threat (for example, removing adware), reinstalling an operating system (OS), and the like.

Further, the response execution means 160 may executes the first response in accordance with the answer received from the different user. For example, suppose the answer received from the different user is to the effect that “the user's answer is not suitable”. In this case, the response execution means 160 may determine that the answer from the user is not suitable and execute a response different from the first response identified based on the answer from the user (for example, disconnection from the network, notification to the different user (manager or the like), alert notification to the personnel responsible for security monitoring, or the like).

Further, for example, when the attack identification means 150 has evaluated the likelihood of the identified phase, the response execution means 160 may determine the first response to be executed in accordance with the likelihood thus evaluated. For example, suppose there are a plurality of options for the type of a threat and the phase. In this case, the response execution means 160 may execute a response to a choice with a maximum likelihood greater than a predetermined threshold.

Further, the response execution means 160 stores a history of responses to threats (hereinafter, referred to as a threat response history) into the response history storage means 170 for each user. The response execution means 160 may evaluate the reliability of the user based on a past threat response history and determine the first response based on the reliability thus evaluated.

The response execution means 160 identifies, when, for example, a threat event occurring in the user terminal 30 is detected, the user of the user terminal 30 and searches for a corresponding threat response history. Then, the response execution means 160 estimates the reliability of the answer from the user based on the number of occurrences of past threats and details of past responses associated with the user, and determines the response to the threat.

For example, when threats greater in number than a predetermined threshold (hereinafter, referred to as a first threshold) have been detected with respect to the user, the response execution means 160 may presume that the user is “careless and untrustworthy” and make the evaluation low. Further, for example, when threats having the same details or of the same type that are greater in number than a predetermined threshold (hereinafter, referred to as a second threshold) have been detected with respect to the user, the response execution means 160 may presume that the user is “careless and untrustworthy person” and make the evaluation low. At this time, the second threshold may be set less than the first threshold.

The response history storage means 170 stores a history of responses executed to threats by the response execution means 160 (that is, the threat response history). FIG. 3 is an explanatory diagram illustrating an example of the threat response history. The example illustrated in FIG. 3 shows that, for each user ID for identifying a corresponding user, the details and type of a threat to which a response has been executed, the result of action, and the date and time of action are stored with all the items associated with each other. With reference to such a threat response history, it is possible to know the number of occurrences (frequency) of each threat. The response history storage means 170 is implemented by, for example, a magnetic disk or the like.

The notification recipient identification means 120, the query creation means 130, the query transmission and reception means 140, the attack identification means 150, and the response execution means 160 are implemented by a CPU of a computer that operates in accordance with a program (threat response program). For example, the program may be stored in a storage (not shown) of the hearing system 100, the CPU may loads the program and operate, in accordance with the program, as the notification recipient identification means 120, the query creation means 130, the query transmission and reception means 140, the attack identification means 150, and the response execution means 160.

Further, the notification recipient identification means 120, the query creation means 130, the query transmission and reception means 140, the attack identification means 150, and the response execution means 160 may be each implemented by a dedicated hardware.

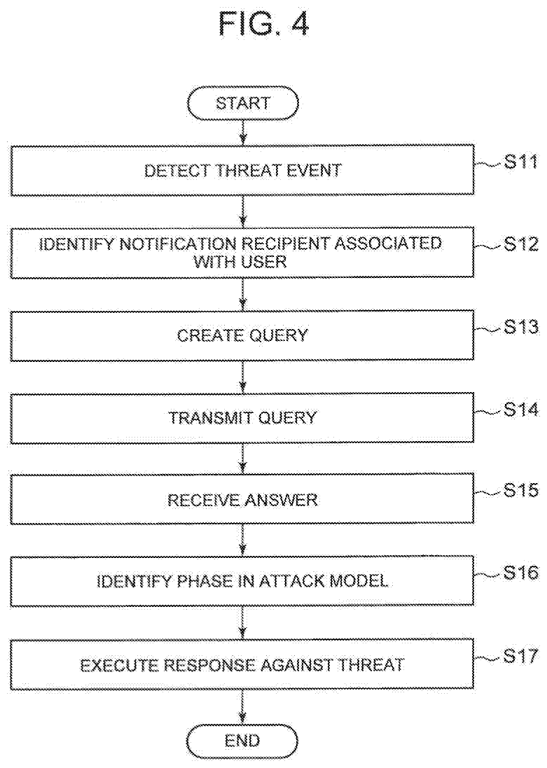

Next, a description will be given of an operation of the threat response system of the present exemplary embodiment. FIG. 4 is a flowchart illustrating an example of the operation of the threat response system of the present exemplary embodiment.

First, the detector 10 detects a threat event that has occurred in the user terminal 30 (step S11). Upon detection of the threat event, the notification recipient identification means 120 uses the database stored in the user information storage means 110 to identify the notification recipient associated with the user of the user terminal 30 in which the threat event has been detected (step S12).

On the other hand, the query creation means 130 creates a query for identifying the phase and type of the threat occurring in the user terminal 30, or the combination of the phase and the type (step S13). Specifically, the query creation means 130 creates, in accordance with the detected threat event, a query for use in identification of, as a cause of a threat, an event caused by the user in the user terminal 30 or an event that has occurred in the user terminal 30 due to the threat from among events that the user becomes aware of.

The query transmission and reception means 140 transmits the created query to the identified notification recipient associated with the user (step S14). Then, the query transmission and reception means 140 receives, from the user, an answer to the transmitted query (step S15). The attack identification means 150 identifies the phase in the attack model based on the received answer (step S16). Note that the attack identification means 150 may also identify the type of the threat. Then, the response execution means 160 executes a response (first response) to the threat indicated by the attack model in accordance with the identified phase (step S17).

As described above, according to the present exemplary embodiment, the notification recipient identification means 120 identifies the notification recipient associated with the user of the user terminal 30 in which the threat event has been detected. Further, the query creation means 130 creates the query for use in identification of the event occurring in the user terminal based on the detected threat event, and the query transmission and reception means 140 transmits the created query to the identified notification recipient associated with the user and receive the answer. Then, the attack identification means 150 identifies the phase in the attack model based on the answer, and the response execution means 160 executes the first response in accordance with the identified phase. Therefore, it is possible to execute a response to ensure security against threats while suppressing an increase in work load on the personnel responsible for security monitoring.

### Exemplary Embodiment 2

Next, a description will be given of a second exemplary embodiment of the threat response system according to the present invention. In the present exemplary embodiment, a description will be given of a method for executing, when a threat event is detected by the detector 10, a response to avoid a threat exhibited by the threat event before giving a query to the user. Note that the response to be executed before giving a query may be referred to as a second response.

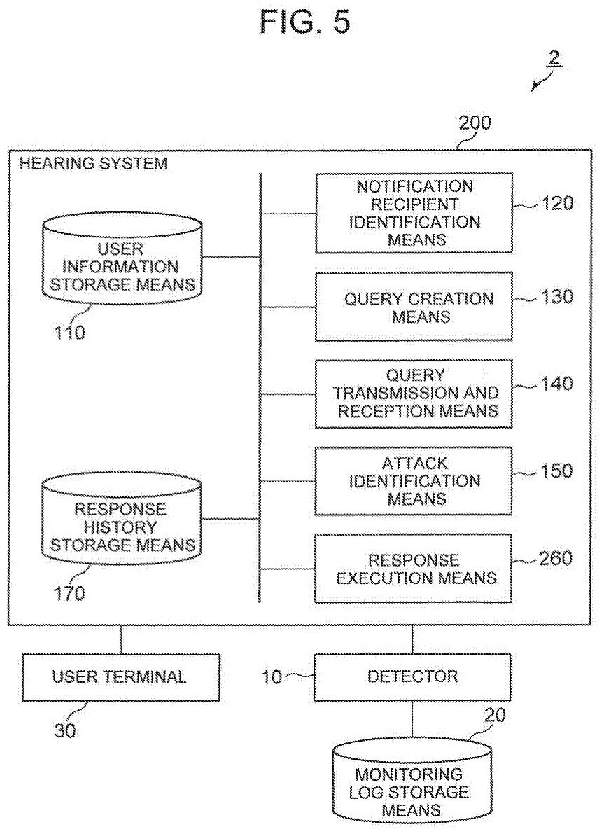

FIG. 5 is a block diagram of the threat response system according to the present invention, illustrating an example of a configuration of the second exemplary embodiment. A threat response system 2 of the present exemplary embodiment includes a detector 10, a monitoring log storage means 20, and a hearing system 200. The detector 10 and the monitoring log storage means 20 of the present exemplary embodiment are the same in configuration as in the first exemplary embodiment.

The hearing system 200 includes a user information storage means 110, a notification recipient identification means 120, a query creation means 130, a query transmission and reception means 140, an attack identification means 150, a response execution means 260, and a response history storage means 170. That is, the hearing system 200 of the present exemplary embodiment includes the response execution means 260 in place of the response execution means 160 of the first exemplary embodiment. The user information storage means 110, the notification recipient identification means 120, the query creation means 130, the query transmission and reception means 140, the attack identification means 150, and the response history storage means 170 are the same in configuration as in the first exemplary embodiment.

Note that, in the present exemplary embodiment, a description will be given of a case where the response execution means 260 executes both the first response and the second response. However, the first response and the second response may be executed by different means. For example, the response execution means 160 of the first exemplary embodiment may execute the first response, and the response execution means 260 of the present exemplary embodiment may execute the second response.

When a threat event is detected by the detector 10, the response execution means 260 executes a response (that is, the second response) to avoid a threat exhibited by the threat event. Therefore, the query transmission and reception means 140 transmits a query after the second response is executed.

Specific examples of the second response include interrupting communication from the user terminal 30 or putting the user terminal 30 into a special network (that is, a quarantine network) for isolation. As described above, when a threat is detected, the response execution means 260 automatically disconnects the user terminal 30 from the normal network, preventing the other terminals from being affected and ensuring security against the threat.

However, the second response is not limited to such responses so-called network isolation. When a threat event is detected, the response execution means 260 activates a mechanism (for example, SDN, access control system, application control system, or the like) that controls access to a device, service, or system, or execution of a service or application. Alternatively, the response execution means 260 may read a user ID from the user information storage means 110 and perform control to execute an application service using the user ID in a restricted manner or to terminate the application service. The activation of such a mechanism allows a more suitable response to be executed on, for example, a cloud environment (Application as a service, Desktop as a service, or the like) where the network isolation would not be a suitable response.

Further, the response execution means 260 may determine whether to execute the second response in accordance with the details of the detected threat event. Specifically, the response execution means 260 may identify the phase in the attack model, the type of the threat, or the combination of the phase and the type based on the details of the detected threat event, and determine whether to execute the second response based on the identified conditions. Further, when failing to identify these conditions from the details of the threat event, the response execution means 260 may execute a predetermined response (for example, interruption of communication or isolation to the quarantine network).

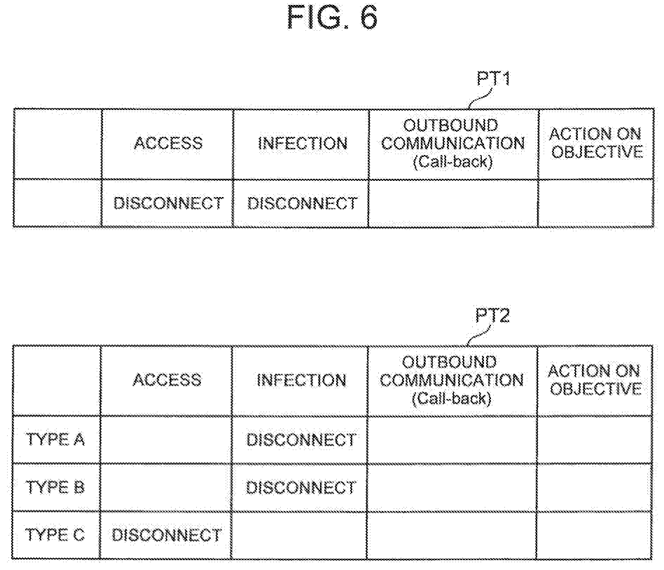

The response execution means 260 may establish, for example, a policy table in advance in accordance with conditions and determine whether to execute the second response based on the policy table. FIG. 6 is an explanatory diagram illustrating an example of the policy table. For example, as in the policy table illustrated in FIG. 6, the second response to be executed in accordance with the phase in the attack model may be predefined. A policy table PT1 illustrated in FIG. 6 shows that a disconnection process is executed when either the phase of “access” or the phase of “infection” is identified from the threat event. Further, for example, as illustrated in a policy table PT2 of FIG. 6, the second response may be predefined for each phase in the attack model and each threat type. The policy table PT2 illustrated in FIG. 6 shows that, when the phase of “access” and a threat type C are identified from the threat event, or the phase of “infection” and a threat type A or threat type C are identified from the threat event, the disconnection process will be executed.

Then, the response execution means 260 determines a response to be executed based on the answer to the query. For example, as the second response, when the user terminal 30 is disconnected from the normal network to which the user terminal 30 is in connection, the response execution means 260 may determine whether to terminate or continue the disconnection from the normal network and execute a response based on the result of the determination. Further, for example, when the user terminal 30 is in the quarantine network for isolation, the response execution means 260 determines whether to allow the user terminal 30 to reconnect to the normal network or continue the isolation based on the answer to the query and execute a response, as the second response, based on the result of the determination.

For example, when the attack identification means 150 fails to identify the phase in the attack model or the type of the threat from the answer to the query, the response execution means 260 may select the continuance of disconnection or continuance of isolation. Further, for example, when a determination is made that a history of past responses for the user is not suitable, the response execution means 260 may select the continuance of disconnection or the continuance of isolation. Examples of a case where a response is not suitable include a case where the user have made “reconnection at user's discretion” the number of times exceeding the predetermined threshold.

Furthermore, the response execution means 260 executes a response in accordance with the identified phase, the identified type of the threat, or the combination of the phase and the type. Note that a method for executing a response in accordance with the identified phase or the like is the same as the method under which the response execution means 160 executes a response according to the first exemplary embodiment. Further, the response execution means 160 of the first exemplary embodiment may determine the first response based on the policy table illustrated in FIG. 6.

As described above, the response execution means 260 determines a response to be executed based on the answer to the query, so that it is possible to prevent deterioration in user convenience as long as the answer is suitable. Further, when the answer from the user is delayed, the disconnection or the isolation will be continued, thereby prompting the user to give the answer.

The notification recipient identification means 120, the query creation means 130, the query transmission and reception means 140, the attack identification means 150, and the response execution means 260 are implemented by a CPU of a computer that operates in accordance with a program (threat response program).

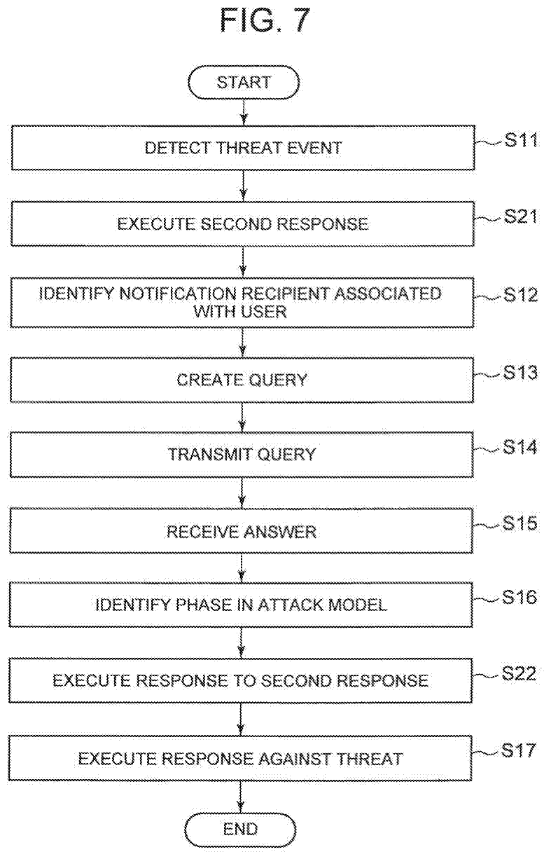

Next, a description will be given of an operation of the threat response system of the present exemplary embodiment. FIG. 7 is a flowchart illustrating an example of the operation of the threat response system of the present exemplary embodiment.

As in step S11 illustrated in FIG. 4, first, the detector 10 detects a threat event that has occurred in the user terminal 30 (step S11). Upon detection of the threat event, the response execution means 260 executes the second response to avoid a threat exhibited by the threat event (step S21). Note that the response execution means 260 may determine whether to execute the second response based on conditions (the phase, the type of the threat, or the combination of the phase and the type) identified from the threat event.

Then, as in step S12 to step S16 illustrated in FIG. 4, a query to be transmitted to the notification recipient associated with the user of the user terminal 30 is created, and a phase in the attack model is identified based on the answer to the created query.

The response execution means 260 executes a response to the executed second response in accordance with the answer to the query (step S22). For example, when the disconnection from the normal network has been made as the second response, the response execution means 260 may make reconnection to the normal network or continuance of the disconnection in accordance with the answer to the query. At the same time, the response execution means 260 executes a response (first response) to the threat indicated by the attack model in accordance with the identified phase (step S17).

As described above, according to the present exemplary embodiment, the response execution means 260 executes, when the threat event is detected by the detector 10, the second response to avoid the threat exhibited by the threat event. Therefore, in addition to the effects of the first exemplary embodiment, it is possible to ensure security against threats.

Note that whether to enable the automatic disconnection described according to the second exemplary embodiment may be determined based on a policy of the user. The same goes for a case where the automatic disconnection is made as the first response according to the first exemplary embodiment. Regarding the phases in the attack model described above, it is considered that the number of detected threats becomes smaller in the order of “access”, “infection”, “outbound communication”, and “action on objective”. However, since the detection of a threat event is not always perfect, it is difficult to clearly define at which phase the automatic disconnection is made. Therefore, a policy of “isolation when in doubt” allows the timing of the automatic disconnection to be set closer to “access” even when the number of threats is large. On the other hand, a policy of “isolation when being certain” allows the timing of the automatic disconnection to be set closer to “action on objective” where the number of threats is small.

The policy of “isolation when in doubt” makes it possible to enhance security. On the other hand, the policy of “isolation when being certain” makes it possible to suppress an increase in work load on the personnel responsible for security monitoring while maintaining convenience of employees.

Hereinafter, a description will be given of a specific example of the present invention. In the following, the operation of the threat response system of the present invention will be described with reference to, as threat types, adware/potentially unwanted application (PUA) and ransomware that are malware. Note that, in this specific example, suppose that the notification recipient associated with the user of the user terminal 30 has been already identified.

Adware/PUA is an application having a function that the user does not intend and is installed without being known to the user. Some types of adware/PUA are designed to cause an advertisement to pop up or install unwanted software or disseminated malware. Further, ransomware is of a type that encrypts a file that can be accessed by an infected terminal to make a ransom demand. Another type of ransomware exploits vulnerabilities to spread infection to other devices.

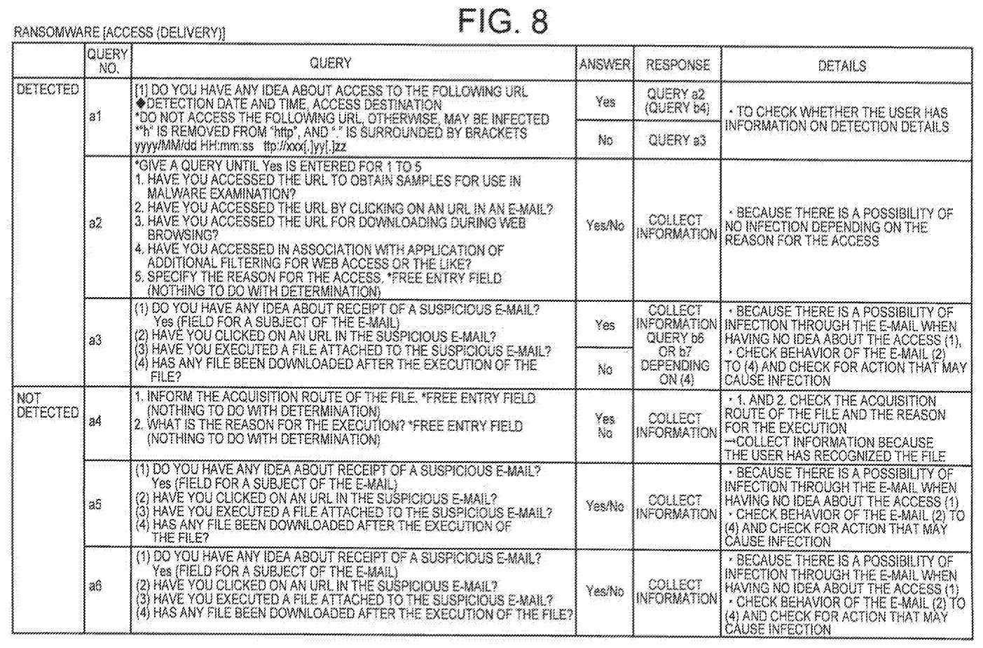

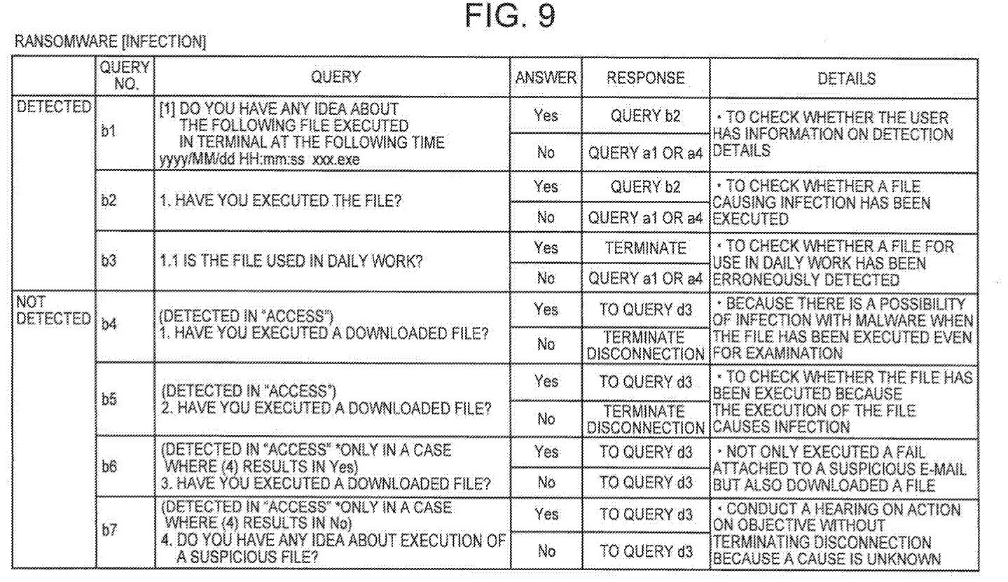

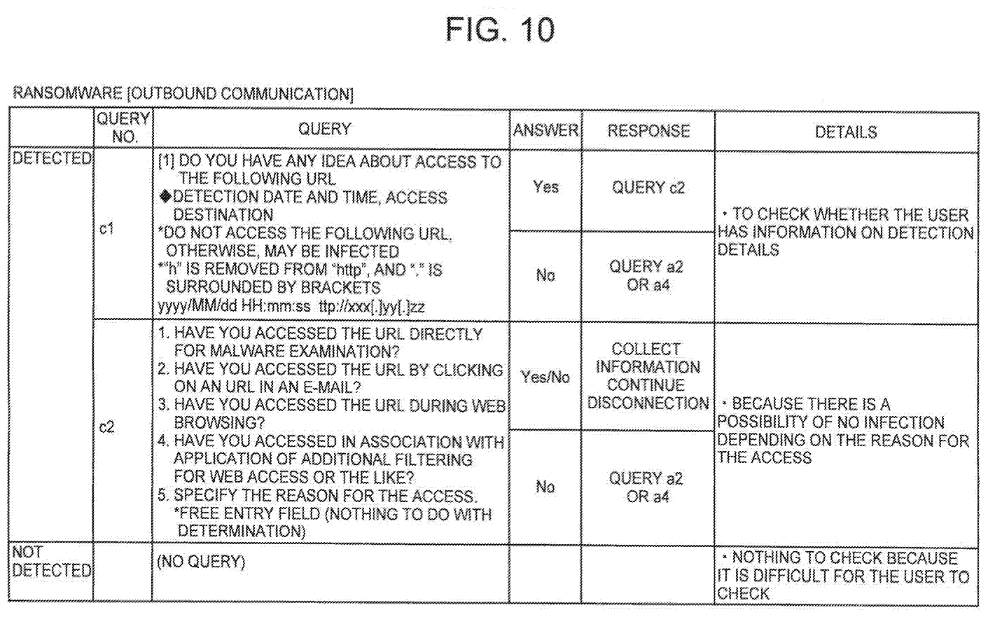

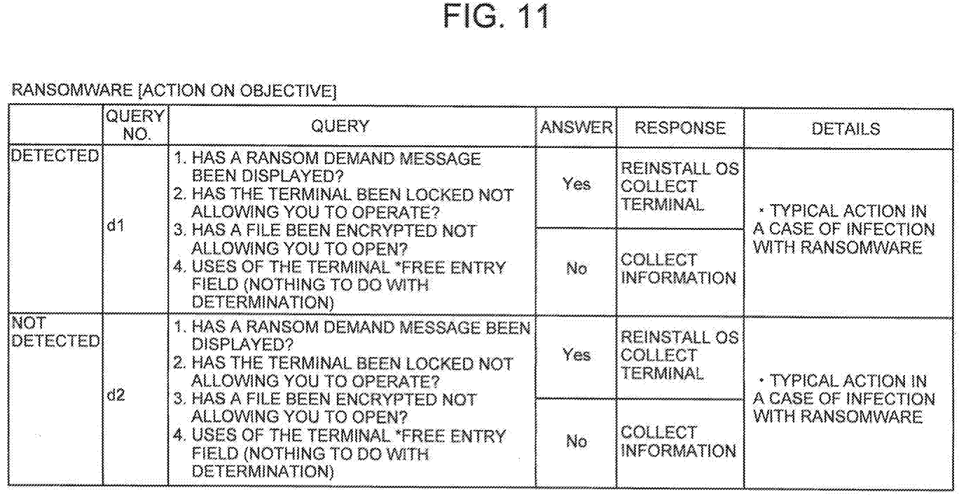

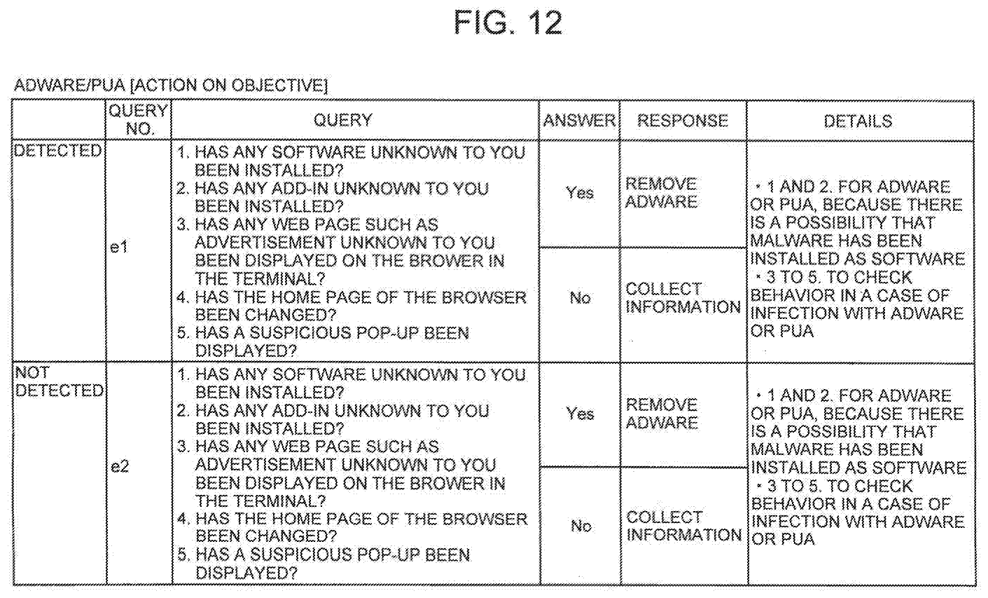

FIG. 8 to FIG. 12 are explanatory diagrams illustrating examples of query tables and responses to threats. Specifically, illustrated in FIG. 8 are examples of queries and responses in accordance with whether a threat event at the phase of “access” is detected. Similarly, illustrated in FIG. 9 are examples of queries and responses in accordance with whether a threat event at the phase of “infection” is detected, and illustrated in FIG. 10 are examples of queries and responses in accordance with whether a threat event at the phase of “outbound communication” is detected. Further, illustrated in FIG. 11 are examples of queries about details of ransomware and responses at the phase of “action on objective”, and illustrated in FIG. 12 are examples of queries about details of adware/PUA and responses at the phase of “action on objective”.

For example, the examples illustrated in FIG. 10 show that, as a query when a threat event related to “outbound communication” is detected, a query c1 and a query c2 are prepared, and responses are defined in accordance with answers (Yes or No) to the queries. Note that the responses include giving another query. Further, for example, the examples illustrated in FIG. 8 show that a query a4, a query a5, and a query a6 that are given, even when a threat event related to “access” is not detected, in accordance with the detection of a threat event at another phase are prepared.

In this specific example, a description will be given of an operation example when the detector 10 detects, as a threat event, “CallBack” that makes outbound communication. The query creation means 130 selects the query c1 illustrated in FIG. 10 based on the detected threat event. The query transmission and reception means 140 transmits the created query to the notification recipient associated with the user. Note that the response execution means 260 may make the interruption of communication or the isolation to the quarantine network before the query is created.

Then, the query transmission and reception means 140 receives the answer to the query. For example, when the answer to the query c1 is “Yes”, the query creation means 130 further selects the query c2. Then, the query transmission and reception means 140 transmits the created query to the notification recipient associated with the user. On the other hand, when the answer to the query c1 is “No”, the query creation means 130 further selects the query a2 or a4. Specifically, when the detector 10 has detected a threat event at the phase of “access”, the query creation means 130 further selects the query a2. On the other hand, when the detector 10 has detected no threat event at the phase of “access”, the query creation means 130 further selects the query a4. Then, the query transmission and reception means 140 transmits the created query to the notification recipient associated with the user.

Herein, suppose the query transmission and reception means 140 receives the answer to the query c2. Regardless of whether the answer to query c2 is “Yes” or “No”, the attack identification means 150 identifies that an attack at the phase of “outbound communication” has been made, and the response execution means 160 (the response execution means 260) continues the disconnection. At the same time, the response execution means 160 collects information on the threat. Furthermore, when there is no answer of “Yes” to the query c2, the query creation means 130 further selects the query a2 or a4 in order to collect more information. Subsequently, the query transmission and reception means 140 transmits the query to the notification recipient associated with the user and receives the answer to the query to collect the information.

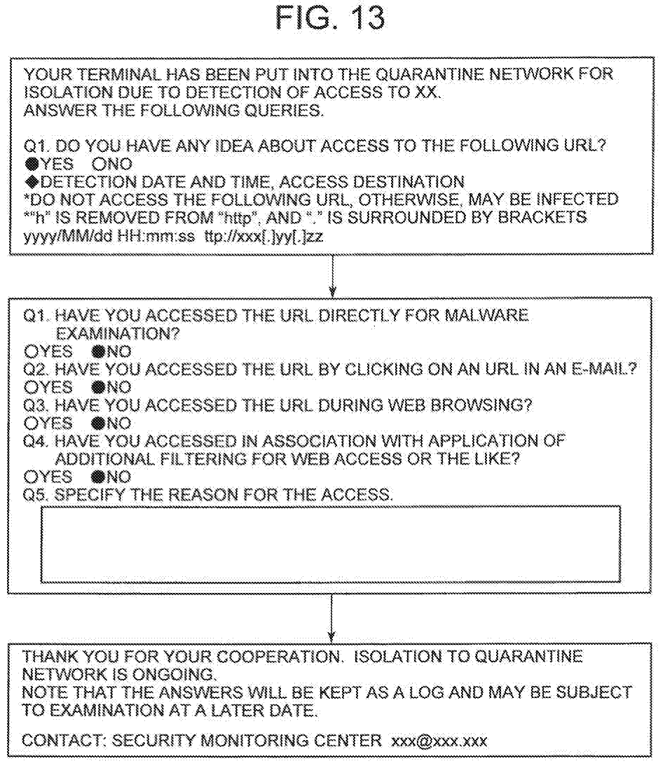

FIG. 13 is an explanatory diagram illustrating an example of processing of displaying a notified query. The user answers Yes or No to the notified query and notifies the hearing system of the answer result. The query creation means 130 may transmit the two types of queries illustrated in FIG. 13 one by one or simultaneously.

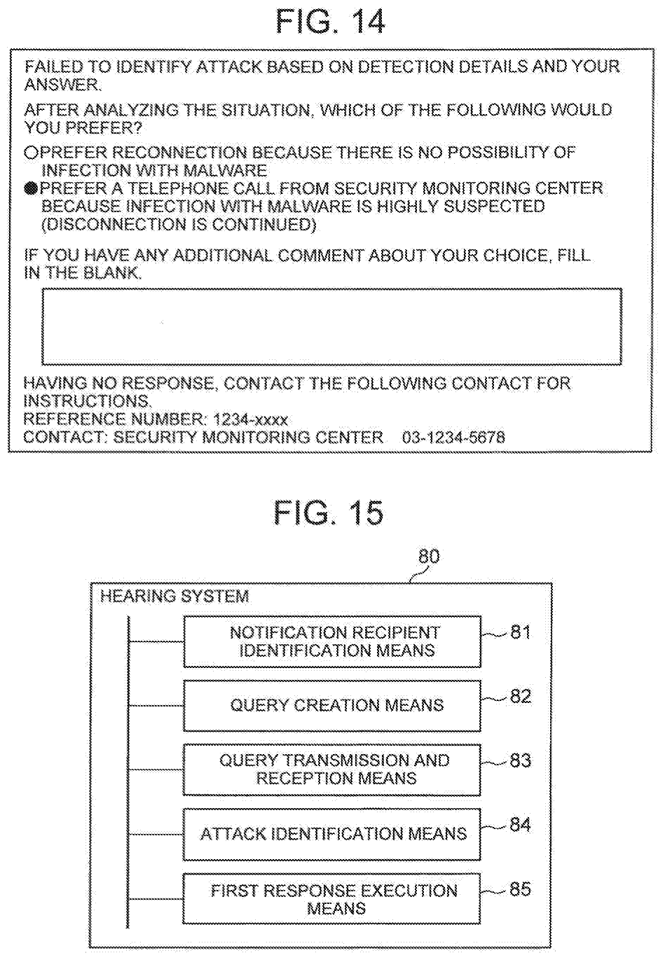

Note that, when the attack identification means 150 fails to identify an attack, the response execution means 260 may notify the user of failure of identification of an attack and allow the user to select a subsequent response. FIG. 14 is an explanatory diagram illustrating an example of notification made upon failure of identification of an attack. As illustrated in FIG. 14, the response execution means 260 may allow the user to directly enter the subsequent response or notify the user of the contact address of a department (for example, a personnel responsible for security monitoring) or the like that executes a response to threats.

The hearing system (threat response system) of the present invention has been described above with reference to specific examples, but the hearing system (threat response system) of the present invention is not limited to the above-described specific examples. Various other policies can be considered as responses to threats.

For example, when the detected details and the answer from the user match the attack model for each malware type, the hearing system may continue the disconnection to prevent reconnection. In particular, since the phases of “infection” and “action on objective” are critical, when either of the phases has been identified, the hearing system may continue the disconnection to prevent reconnection. On the other hand, when the detected details and the answer from the user do not match the attack model for each malware type, the hearing system allows reconnection.

Further, for example, suppose when a threat event exhibiting “access” or “outbound communication” is detected, and a query for confirming the presence or absence of infection is transmitted, the user answers that there is no infection. Herein, when the phase in the attack model cannot be determined from the detected details and the answer from the user, the hearing system may prompt the user to determine conditions and change a response in accordance with the answer.

Further, when the user desires reconnection at the discretion of the user, the hearing system may allow reconnection, and the personnel responsible for security monitoring may augment the monitoring for a certain period. Further, when the user desires to make contact with the personnel responsible for security monitoring, the hearing system may continue disconnection. Then, the personnel responsible for security monitoring may again give a query to the user about the conditions in accordance with the monitoring log and the answer and determine whether to continue disconnection or allow reconnection.

Next, a description will be given of an outline of the present invention. FIG. 15 is a block diagram schematically illustrating the hearing system according to the present invention. A hearing system 80 (for example, the hearing system 100 or the hearing system 200) according to the present invention includes a notification recipient identification means 81 (for example, the notification recipient identification means 120) that uses a database in which a user terminal (for example, the user terminal 30) and a notification recipient associated with a user are associated with each other to identify the notification recipient associated with the user of the user terminal in which a threat event has been detected, a query creation means 82 (for example, the query creation means 130) that creates, in accordance with the threat event detected, at least one query for use in identification of, as a cause of the threat, an event caused by the user in the user terminal, or an event that has occurred in the user terminal due to the threat from among events that the user becomes aware of, a query transmission and reception means 83 (for example, the query transmission and reception means 140) that transmits the query created to the notification recipient associated with the user identified and receives an answer to the query from the user, an attack identification means 84 (the attack identification means 150) that identifies, based on the answer, a phase in the attack model representing phases of a series of attacks identified based on a type of the threat, and a first response execution means 85 (for example, the response execution means 160) that executes a first response to the threat indicated by the attack model in accordance with the phase identified.

With such a configuration, it is possible to execute a response to ensure security against threats while suppressing an increase in work load on a personnel responsible for security monitoring.

Further, the attack identification means 84 may identify the phase in the attack model and the type of the threat based on the answer from the user. Then, the first response execution means 85 may execute the first response in accordance with the identified phase and the identified type of the threat. With such a configuration, it is possible to execute a more suitable response in accordance with the type of the threat.

Further, the hearing system 80 (for example, the hearing system 200) may include a second response execution means (for example, the response execution means 260) that executes, when a threat event is detected, a second response to avoid a threat exhibited by the threat event. Then, the query transmission and reception means 83 may transmit the query after the second response is executed. With such a configuration, it is possible to further ensure security against threats.

Further, the second response execution means may execute a response, as the second response, to disconnect the user terminal from a normal network to which the user terminal is in connection, or a response to put the user terminal into a quarantine network for isolation.

Further, the first response execution means may execute, in accordance with the answer to the query, a response to terminate disconnection from the normal network or allow reconnection to the normal network, or alternatively, to continue disconnection or continue isolation.

Further, the query creation means 82 may create a query from a query table in which queries are defined in accordance with types of threats and phases identified based on threat events. Then, the attack identification means 84 may refer to the query table to identify a phase based on the answer to the query from the user.

Further, the query transmission and reception means 83 may transmit a query indicating suitability of the answer received from the user to a different user other than the user (for example, a manager or the like) and receive an answer from the different user, and the first response execution means 85 may execute the first response in accordance with the answer received from the different user. With such a configuration, it is possible to increase the reliability of an answer.

Further, the attack identification means 84 may evaluate the likelihood of the identified phase based on the answer to each query from the user. Then, the first response execution means 85 may determine the first response to be executed in accordance with the evaluated likelihood.

Further, the hearing system 80 may include a response history storage means (for example, the response history storage means 170) that stores a threat response history for each user. Then, the first response execution means 85 may evaluate the reliability of the user based on the response threat history and determine the first response based on the evaluated reliability.

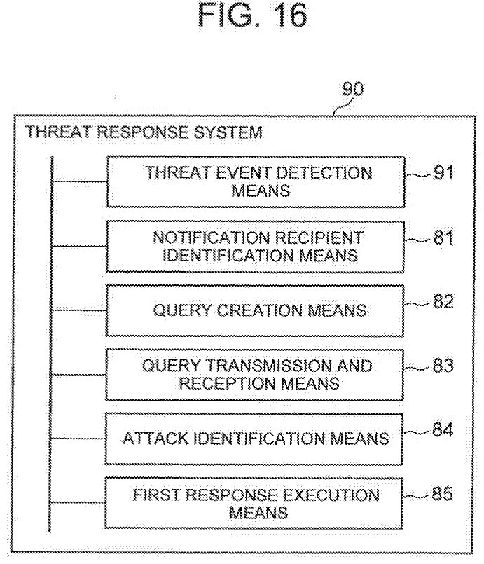

FIG. 16 is a block diagram schematically illustrating a threat response system according to the present invention. A threat response system 90 (for example, the threat response system 1 or the threat response system 2) according to the present invention includes a threat event detection means 91 that detects a threat event that has occurred in a user terminal (for example, the user terminal 30), the notification recipient identification means 81, the query creation means 82, the query transmission and reception means 83, the attack identification means 84, and the first response execution means 85. The notification recipient identification means 81, the query creation means 82, the query transmission and reception means 83, the attack identification means 84, and the first response execution means 85 are the same in configuration as in the hearing system 80 illustrated in FIG. 15.

With such a configuration as well, it is possible to execute a response to ensure security against threats while suppressing an increase in work load on the personnel responsible for security monitoring.

All or some of the above-described exemplary embodiments may be described as follows, but are not limited to the following.

(Supplementary note 1) A hearing system includes a notification recipient identification means that uses a database in which a user terminal and a notification recipient associated with a user are associated with each other to identify the notification recipient associated with the user of the user terminal in which a threat event has been detected, a query creation means that creates, in accordance with the threat event detected, at least one query for use in identification of, as a cause of a threat, an event caused by the user in the user terminal or an event that has occurred in the user terminal due to the threat from among events that the user becomes aware of, a query transmission and reception means that transmits the query created to the notification recipient associated with the user identified and receives an answer to the query from the user, an attack identification means that identifies, in an attack model representing phases of a series of attacks identified based on a type of the threat, a corresponding one of the phases based on the answer, and a first response execution means that executes a first response to the threat indicated by the attack model in accordance with the phase identified.

(Supplementary note 2) In the hearing system described in Supplementary note 1, the attack identification means identifies the phase in the attack model and the type of the threat based on the answer from the user, and the first response execution means executes the first response in accordance with the phase and the type of the threat identified.

(Supplementary note 3) The hearing system described in Supplementary note 1 or 2 further includes a second response execution means that executes, when a threat event is detected, a second response to avoid a threat exhibited by the threat event, and the query transmission and reception means transmits the query after the second response is executed.

(Supplementary note 4) In the hearing system described in Supplementary note 3, the second response execution means executes, as the second response, a response to disconnect the user terminal from a normal network to which the user terminal is in connection, or a response to put the user terminal into a quarantine network for isolation.

(Supplementary note 5) In the hearing system described in Supplementary note 4, the first response execution means executes, in accordance with the answer to the query, a response to terminate the disconnection from the normal network or allow reconnection to the normal network, or a response to continue the disconnection or isolation.

(Supplementary note 6) In the hearing system described in any one of Supplementary notes 1 to 5, the query creation means creates the query from a query table in which queries are defined in accordance with types of threats and phases identified based on threat events, and the attack identification means refers to the query table to identify the phase based on the answer to the query from the user.

(Supplementary note 7) In the hearing system described in any one of Supplementary notes 1 to 6, the query transmission and reception means transmits a query indicating suitability of the answer received from the user to a different user other than the user and receives an answer from the different user, and the first response execution means executes the first response in accordance with the answer received from the different user.

(Supplementary note 8) In the hearing system described in any one of Supplementary notes 1 to 7, the attack identification means evaluates, based on the answer to each query from the user, likelihood of the phase identified, and the first response execution means determines the first response to be executed in accordance with the likelihood evaluated.

(Supplementary note 9) The hearing system described in any one of Supplementary notes 1 to 8 further includes a response history storage means that stores a threat response history for each user, and the first response execution means evaluates reliability of the user based on the threat response history, and determines the first response based on the reliability evaluated.

(Supplementary note 10) A threat response system includes a threat event detection means that detects a threat event that has occurred in a user terminal, a notification recipient identification means that uses a database in which the user terminal and a notification recipient associated with a user are associated with each other to identify the notification recipient associated with the user of the user terminal in which the threat event has been detected, a query creation means that creates, in accordance with the threat event detected, at least one query for use in identification of, as a cause of a threat, an event caused by the user in the user terminal or an event that has occurred in the user terminal due to the threat from among events that the user becomes aware of, a query transmission and reception means that transmits the query created to the notification recipient associated with the user identified and receives an answer to the query from the user, an attack identification means that identifies, in an attack model representing phases of a series of attacks identified based on a type of the threat, a corresponding one of the phases based on the answer, and a first response execution means that executes a first response to the threat indicated by the attack model in accordance with the phase identified.

(Supplementary note 11) A threat response method includes using a database in which a user terminal and a notification recipient associated with a user are associated with each other to identify the notification recipient associated with the user of the user terminal in which a threat event has been detected, creating, in accordance with the threat event detected, at least one query for use in identification of, as a cause of a threat, an event caused by the user in the user terminal or an event that has occurred in the user terminal due to the threat from among events that the user becomes aware of, transmitting the query created to the notification recipient associated with the user identified and receiving an answer to the query from the user, identifying, in an attack model representing phases of a series of attacks identified based on a type of the threat, a corresponding one of the phases based on the answer, and executing a first response to the threat indicated by the attack model in accordance with the phase identified.

(Supplementary note 12) A threat response program causes a computer to execute notification recipient identification processing of using a database in which a user terminal and a notification recipient associated with a user are associated with each other to identify the notification recipient associated with the user of the user terminal in which a threat event has been detected, query creation processing of creating, in accordance with the threat event detected, at least one query for use in identification of, as a cause of a threat, an event caused by the user in the user terminal or an event that has occurred in the user terminal due to the threat from among events that the user becomes aware of, query transmission and reception processing of transmitting the query created to the notification recipient associated with the user identified and receiving an answer to the query from the user, attack identification processing of identifying, in an attack model representing phases of a series of attacks identified based on a type of the threat, a corresponding one of the phases based on the answer, and first response execution processing of executing a first response to the threat indicated by the attack model in accordance with the phase identified.

Although the invention of the present application has been described above with reference to the exemplary embodiments and the examples, the invention of the present application is not limited to the exemplary embodiments and the examples. Various changes that can be understood by those skilled in the art can be made to the configuration and details of the invention of the present application within the scope of the invention of the present application.

This application claims priority based on Japanese Patent Application No. 2018-052077 filed on Mar. 20, 2018, the disclosure of which is incorporated herein in its entirety.

### REFERENCE SIGNS LIST

1, 2 Threat response system
10 Detector
20 Monitoring log storage means
30 User terminal
100,200 Hearing system
110 User information storage means
120 Notification recipient identification means
130 Query creation means
140 Query transmission and reception means
150 Attack identification means
160,260 Response execution means
170 Response history storage means

What is claimed is:

1. A hearing system comprising a hardware processor configured to execute a software code to:
use a database in which a user terminal and a notification recipient associated with a user are associated with each other to identify the notification recipient associated with the user of the user terminal in which a threat event has been detected;
create, in accordance with the threat event detected, at least one query for use in identification of, as a cause of a threat, an event caused by the user in the user terminal or an event that has occurred in the user terminal due to the threat from among events that the user becomes aware of;
transmit the query created to the notification recipient associated with the user identified and receive an answer to the query from the user;
identify, in an attack model representing phases of a series of attacks identified based on a type of the threat, a corresponding one of the phases based on the answer; and
execute a first response to the threat indicated by the attack model in accordance with the phase identified.

2. The hearing system according to claim 1, wherein the hardware processor is configured to execute a software code to:
identify the phase in the attack model and the type of the threat based on the answer from the user, and
execute the first response in accordance with the phase and the type of the threat identified.

3. The hearing system according to claim 1, wherein the hardware processor is configured to execute a software code to:
execute, when a threat event is detected, a second response to avoid a threat exhibited by the threat event, and
transmit the query after the second response is executed.

4. The hearing system according to claim 3, wherein the hardware processor is configured to execute a software code to execute, as the second response, a response to disconnect the user terminal from a normal network to which the user terminal is in connection, or a response to put the user terminal into a quarantine network for isolation.

5. The hearing system according to claim 4, wherein the hardware processor is configured to execute a software code to execute, in accordance with the answer to the query, a response to terminate the disconnection from the normal network or allow reconnection to the normal network, or a response to continue the disconnection or isolation.

6. The hearing system according to claim 1, wherein the hardware processor is configured to execute a software code to create the query from a query table in which queries are defined in accordance with types of threats and phases identified based on threat events, and
refer to the query table to identify the phase based on the answer to the query from the user.

7. The hearing system according to claim 1 wherein the hardware processor is configured to execute a software code to:
transmit a query indicating suitability of the answer received from the user to a different user other than the user and receive an answer from the different user, and
execute the first response in accordance with the answer received from the different user.

8. The hearing system according to claim 1, wherein the hardware processor is configured to execute a software code to:
evaluate based on the answer to each query from the user, likelihood of the phase identified, and
determine the first response to be executed in accordance with the likelihood evaluated.

9. The hearing system according to claim 1, further comprising a response history storage means that stores a threat response history for each user,
wherein the hardware processor is configured to execute a software code to evaluate reliability of the user based on the threat response history, and determine the first response based on the reliability evaluated.

10. A threat response system comprising: comprising a hardware processor configured to execute a software code to:
detect a threat event that has occurred in a user terminal;
use a database in which the user terminal and a notification recipient associated with a user are associated with each other to identify the notification recipient associated with the user of the user terminal in which the threat event has been detected;
create, in accordance with the threat event detected, at least one query for use in identification of, as a cause of a threat, an event caused by the user in the user terminal or an event that has occurred in the user terminal due to the threat from among events that the user becomes aware of;
transmit the query created to the notification recipient associated with the user identified and receives an answer to the query from the user;
identify, in an attack model representing phases of a series of attacks identified based on a type of the threat, a corresponding one of the phases based on the answer; and
execute a first response to the threat indicated by the attack model in accordance with the phase identified.

11. A threat response method comprising:
using a database in which a user terminal and a notification recipient associated with a user are associated with each other to identify the notification recipient associated with the user of the user terminal in which a threat event has been detected;
creating, in accordance with the threat event detected, at least one query for use in identification of, as a cause of a threat, an event caused by the user in the user terminal or an event that has occurred in the user terminal due to the threat from among events that the user becomes aware of;
transmitting the query created to the notification recipient associated with the user identified and receiving an answer to the query from the user;
identifying, in an attack model representing phases of a series of attacks identified based on a type of the threat, a corresponding one of the phases based on the answer; and
executing a first response to the threat indicated by the attack model in accordance with the phase identified.

12. A non-transitory computer readable information recording medium storing a threat response program, when executed by a processor, that performs a method for:
using a database in which a user terminal and a notification recipient associated with a user are associated with each other to identify the notification recipient associated with the user of the user terminal in which a threat event has been detected;
creating, in accordance with the threat event detected, at least one query for use in identification of, as a cause of a threat, an event caused by the user in the user terminal or an event that has occurred in the user terminal due to the threat from among events that the user becomes aware of;
transmitting the query created to the notification recipient associated with the user identified and receiving an answer to the query from the user;
identifying, in an attack model representing phases of a series of attacks identified based on a type of the threat, a corresponding one of the phases based on the answer; and
executing a first response to the threat indicated by the attack model in accordance with the phase identified.
